(19) United States
(12) Patent Application Publication
(10) Pub. No.: US 2026/0159907 A1
(43) Pub. Date: Jun. 11, 2026

(54) METHOD FOR MANUFACTURING RECYCLED LEATHER BY USING LEATHER

(71) Applicants: Soon Jung Park, Busan (KR); JOIL INDUSTRIAL CO., LTD., Busan (KR)

(72) Inventor: Soon Jung Park, Busan (KR)

(73) Assignees: Soon Jung Park, Busan (KR); JOIL INDUSTRIAL CO., LTD., Busan (KR)

(21) Appl. No.: 18/857,808

(22) PCT Filed: Feb. 24, 2023
(86) PCT No.: PCT/KR2023/002647

§ 371 Date: Oct. 17, 2024

(30) Foreign Application Priority Data
Jul. 27, 2022 (KR) 10-2022-0092929
Oct. 27, 2022 (KR) 10-2022-0140152

(51) Int. Cl. C14B 7/02; C14B 13/00; D06N 3/00

(52) U.S. Cl. CPC C14B 7/02; C14B 13/00; D06N 3/007; D06N 2211/28

(57) ABSTRACT

manufacturing recycled leather by using leather. In the present invention, a method for manufacturing leather using a resin and a substrate sheet is technically characterized by comprising the steps of: crushing scraps or waste products generated during the cutting or production of genuine leather to produce crushed leather particles; classifying the crushed leather particles by particle size or component; mixing the crushed leather particles with the resin used in the manufacture of the leather; and dissolving the crushed leather particles in a solvent, followed by filtration for use.

### TECHNICAL FIELD

The present disclosure relates to a method for manufacturing recycled leather by using leather.

### BACKGROUND ART

In general, surplus leather products, leather scraps generated during cutting or production, or unusable leather products are mostly disposed of by landfilling or incineration since their application range is very limited, thus posing a serious environmental problem.

Recently, various studies have been conducted to recycle surplus leather products, leather scraps generated during cutting or production, or unusable leather products without incineration or landfilling. For example, there are ‘Recycle leather sheet manufacturing method using eco-leather which be able to needlework” (KR 10-0829058 B1)’, ‘Manufacture method of sheet using eco-leather (KR 10-0815634 B1)’, ‘Method of making sheet material for fashion based on recycling leather using wet-dry making method (KR 10-1584171 B1)’, and ‘Sheet for synthetic leather and manufacturing method thereof (KR 10-0962042 B1)’.

However, the above related-art technologies are based on a simple bonding method using latex, an adhesive material, so the recycled material has very poor tensile strength and tear strength, and when remanufactured into leather, the resulting material is used only for limited purposes due to its very poor flexibility, tensile strength, and tear strength. In addition, since it is impossible to modify the surface properties, there is a problem that marketability and economic feasibility are greatly reduced when attaching a film or non-woven fabric.

As such, the above related-art technologies have extremely limited uses for decorative interior materials, wallpaper, and the like, and are difficult to apply to products that require durability and elasticity against repeated external forces and continuous contact with users and objects, such as footwear and car seats. In other words, there are still limitations due to the problem of not satisfying the physical properties such as tensile strength, tear strength, flexibility, and thickness required in various industrial fields.

### DISCLOSURE

### Technical Problem

Accordingly, the present disclosure has been made keeping in mind the above problems occurring in the related art, and an objective of the present disclosure is to provide a method for manufacturing upcycled recycled leather by using leather such as artificial leather or natural leather.

### Technical Solution

In order to accomplish the above objective, the present disclosure provides a method for manufacturing recycled leather by using leather, the method manufacturing artificial leather or natural leather (hereinafter referred to as ‘leather’) by using a resin and a base sheet, and the method including: preparing crushed leather particles by crushing surplus leather products, leather scraps generated during cutting or production, or unusable leather products; and mixing the crushed leather particles with the resin used in the manufacturing of the leather.

In the present disclosure, the preparing of the crushed leather particles may be performed by crushing the leather and classifying the crushed leather by particle size or component to prepare the crushed leather particles.

In the present disclosure, the crushed leather particles may include a base agglomerate that results from entangling base sheet components when classifying the crushed leather by particle size or component.

In the present disclosure, the base agglomerate may be used when mixed with the resin or may be discarded.

In the present disclosure, the base sheet may be at least one of a film, fabric, knitted fabric, non-woven fabric, and natural leather.

In the present disclosure, the leather may be wet-dry artificial leather manufactured by: a wet step of wet-impregnating the base sheet with the resin to manufacture a resin-impregnated base sheet and then applying the resin to an upper surface of the resin-impregnated base sheet to manufacture a wet sheet coated with a wet resin layer (hidden layer) (hereinafter referred to as ‘resin layer’); a dry step of applying the resin to a release paper layer to form a skin layer and then stacking an adhesive layer to manufacture a dry sheet; and a bonding step of arranging the resin layer and the skin layer to face each other and then bonding the wet sheet and the dry sheet with the adhesive layer. The crushed leather particles may be mixed with the resin used in the wet step or the dry step.

In the present disclosure, the leather may be suede manufactured by: a suede base manufacturing step of impregnating the base sheet with the resin to manufacture a suede base; and a buffing step of polishing a surface of the suede base. The crushed leather particles may be mixed with the resin used in the suede base manufacturing step.

In the present disclosure, the leather may be dry artificial leather manufactured by: a base sheet preparation step of preparing the base sheet; a dry step of applying the resin to a release paper layer to form a skin layer and then stacking an adhesive layer to manufacture a dry sheet; and a bonding step of arranging the base sheet and the skin layer to face each other and then bonding the base sheet and the dry sheet with the adhesive layer. The crushed leather particles may be mixed with the resin used in the dry step.

In the present disclosure, the base sheet preparation step may be performed by dry-impregnating the base sheet with the resin to manufacture a resin-impregnated base sheet and then applying the resin to an upper surface of the resin-impregnated base sheet to prepare the base sheet coated with a dry resin layer. The crushed leather particles may be mixed with the resin used in the base sheet preparation step.

In the present disclosure, the crushed leather particles may be used by classifying the crushed leather particles by particle size or component.

In the present disclosure, the crushed leather particles may be used by dissolving the crushed leather particles in a solvent and then filtering the crushed leather particles.

In the present disclosure, the crushed leather particles may be mixed with the resin applied to the release paper layer to form a stardust pattern on a surface of the skin layer.

### Advantageous Effects

According to the present disclosure having the above configuration, by manufacturing recycled leather by crushing or additionally classifying and reusing surplus leather products, leather scraps generated during cutting or production, or unusable leather products, it is possible to prevent environmental pollution and improve design elements. The recycled leather can be widely used in various products such as footwear, furniture, bag products, clothing, and car seats.

### DESCRIPTION OF DRAWINGS

FIG. 1 is a flowchart illustrating a method for recycling surplus leather products, leather scraps generated during cutting or production, or unusable leather products.

FIG. 2 is an exemplary view illustrating a classification device according to the present disclosure.

FIG. 3 is a view illustrating images of first particles separated by the classification device according to the present disclosure.

FIG. 4 is a view illustrating 4 second particles separated by the classification device according to the present disclosure.

FIG. 5 is a flowchart illustrating a method for manufacturing wet-dry artificial leather.

FIG. 6 is a flowchart illustrating a method for manufacturing wet artificial leather (suede).

FIG. 7 is a flowchart illustrating a method for manufacturing dry artificial leather.

FIG. 8 is an image of a skin layer with a stardust pattern formed on a surface.

FIG. 9 is an image of recycled leather to which the skin layer with the stardust pattern formed on the surface is applied.

### BEST MODE

The present disclosure may be modified in various ways and implemented by various embodiments, so that specific embodiments are shown in the drawings and will be described in detail. However, it is to be understood that the present disclosure is not limited to the specific exemplary embodiments, but includes all modifications, equivalents, and substitutions included in the spirit and the scope of the present disclosure.

Terms used herein are used only in order to describe specific embodiments rather than limiting the present disclosure. As used herein, the singular forms are intended to include the plural forms as well, unless the context clearly indicates otherwise. It will be further understood that the terms “comprises” or “have” used in this specification, specify the presence of stated features, processes, operations, components, parts, or a combination thereof, but do not preclude the presence or addition of one or more other features, numerals, processes, operations, components, parts, or a combination thereof.

Unless otherwise defined, all terms including technical and scientific terms used herein have the same meaning as commonly understood by one of ordinary skill in the art to which the present disclosure belongs. It should be understood that the terms defined by the dictionary are identical with the meanings within the context of the related art, and they should not be ideally or excessively formally defined unless the context clearly dictates otherwise in this specification.

Hereinbelow, repeated descriptions detailed descriptions of known functions and components incorporated herein will be omitted when it may make the subject matter of the present disclosure unclear. The embodiment of the present disclosure described hereinbelow is provided for allowing those skilled in the art to more clearly comprehend the present disclosure.

The present disclosure relates to a method for manufacturing artificial leather o natural leather (hereinafter referred to as ‘leather’) by using a resin and a base sheet. That is, in the present disclosure, recycled leather may be manufactured by using surplus leather products, leather scraps generated during cutting or production, or unusable leather products through the steps of: preparing crushed leather particles by crushing surplus leather products, leather scraps generated during cutting or production, or unusable leather products; and mixing the crushed leather particles with a resin used in the manufacturing of the leather.

Here, the base sheet may be at least one of a film, fabric, knitted fabric, non-woven fabric, and natural leather. In addition to the above types, various types can be used as long as they can function as a base sheet for leather. Among these, when using a base sheet such as fabric, knitted fabric, or non-woven fabric, the base sheet may be “impregnated” with a resin or “coated with a resin layer after impregnation”. In the case of fabric and knitted fabric, they are more often used immediately without impregnation or without being coated with a resin layer after impregnation, and in the case of non-woven fabric, it is more often used after being impregnated or coated with a resin layer after impregnation than when used immediately. In the case of a film, due to its structure, the resin cannot permeate into the film even after impregnation, so it is preferable that it is manufactured as dry artificial leather without being impregnated or coated with a resin layer after impregnation. In the case of natural leather, animal skin has dense collagen tissue, a type of protein, and is not impregnated with the resin. Therefore, when making leather from natural leather, the resin is applied to a release paper layer to form a skin layer, and adhesive is applied thereon, and then it is immediately bonded to the natural leather in a face-to-face manner. In addition, methods of impregnation and resin layer application after impregnation can be divided into a wet method and a dry method. Wet-dry artificial leather is manufactured in such a manner that knitted fabric, fabric, or non-woven fabric is wet-impregnated or wet-impregnated and then coated with a wet resin layer, a resin is applied to a release paper layer, and then it is bonded to a dry sheet coated with an adhesive in a face-to-face manner. Dry artificial leather is manufactured in such a manner that an adhesive is applied to a release paper layer and then any type of base sheet is bonded to a dry sheet coated with a resin in a face-to-face manner without being wet-impregnated or coated with a wet resin layer after impregnation. In the case of the dry artificial leather, depending on the type of base sheet, the base sheet may also be dry-impregnated or coated with a dry resin layer after dry impregnation.

To prepare crushed leather particles, first, surplus leather products, leather scraps generated during cutting or production, or unusable leather products are crushed.

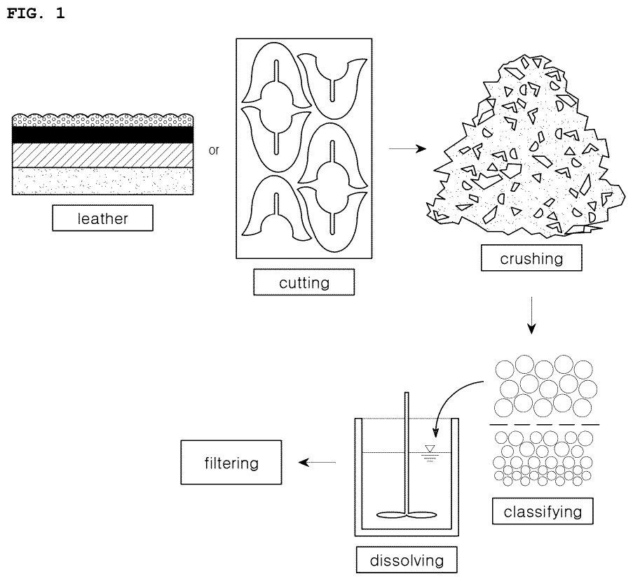

FIG. 1 is a flowchart illustrating a method for recycling surplus leather products, leather scraps generated during cutting or production, or unusable leather products. Referring to FIG. 1, surplus leather products, leather scraps generated during cutting or production, or unusable leather products are collected, crushed, and classified by particle size or component to prepare crushed leather particles. When leather is crushed, depending on the degree of cutting, only the base sheet component may be present, or the base sheet component and the resin component may be present together.

Depending on the type of leather, it may have elasticity when crushed or may melt due to its low heat resistance. For example, when a film is used as a base sheet and cutting is not easily performed at room temperature, cutting is achieved by mixing a cryogenic material, such as liquid nitrogen, or an abrasive. In other cases, crushing is performed at room temperature.

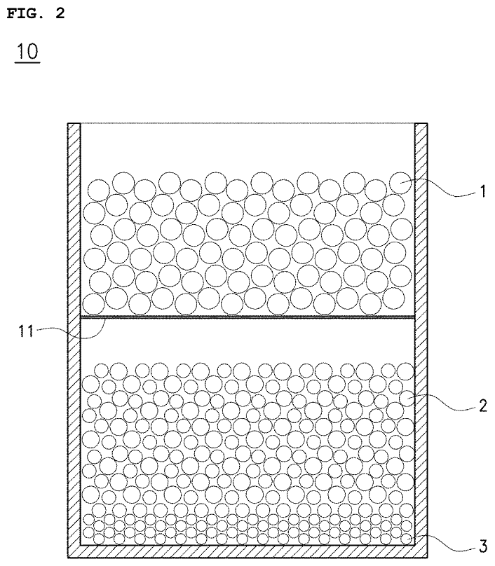

When the surplus leather products, leather scraps generated during cutting or production, or unusable leather products are crushed as described above, the size of resulting particles is not uniform, so classification is performed. As illustrated in FIG. 2, which illustrates a classification device 10 according to the present disclosure, classification is performed using the classification device 10. Here, classification is achieved according to o particle size or component by applying vibration or ultrasonic waves.

Referring to the classification device 10 illustrated in FIG. 2, the classification device 10 is provided with at least one mesh-shaped filter 11 that separates an upper area and a lower area. When vibration or ultrasonic waves are applied to the classification device 10, the crushed leather particles may be classified by particle size, for example, into first particles 1 with a particle size of equal to or greater than 1 mm and second particles 2 with a particle size of less than 1 mm. The first particles 1 with a particle size of equal to or greater than 1 mm exist in the upper area of the filter 11, and the second particles 2 with a particle size of less than 1 mm exist in the lower area of the filter 11. Here, when an additional filter (for example, a 0.5 mm filter) is installed in the classification device 10, the particles may be classified into sizes of equal to or greater than 1 mm, 1 to 0.5 mm, and less than 0.5 mm, and may be further classified into various sizes depending on the number of filters installed.

Here, the crushed leather particles may include a base agglomerate that results from entangling the base sheet components when classifying the crushed leather by particle size or component. The base agglomerate may be used when mixed with the resin or may be discarded.

Specifically, when the crushed leather is classified by applying vibration or ultrasonic waves, the first particles 1 with a particle size of equal to or greater than 1 mm float to the top of the filter 11, and the second particles 2 and third particles 3 with a particle size of less than 1 mm sink to the bottom of the classification device 10. Here, the first particles 1 may be formed in the form of granules as the base sheet components, which are light in weight among the components of the crushed leather particles, are fibrous and entangled like cotton and float to the top of the classification device 10, and they may be particles mainly composed of the base sheet component. The second particles 2 and the third particles 3 may be particles mainly composed of the resin component.

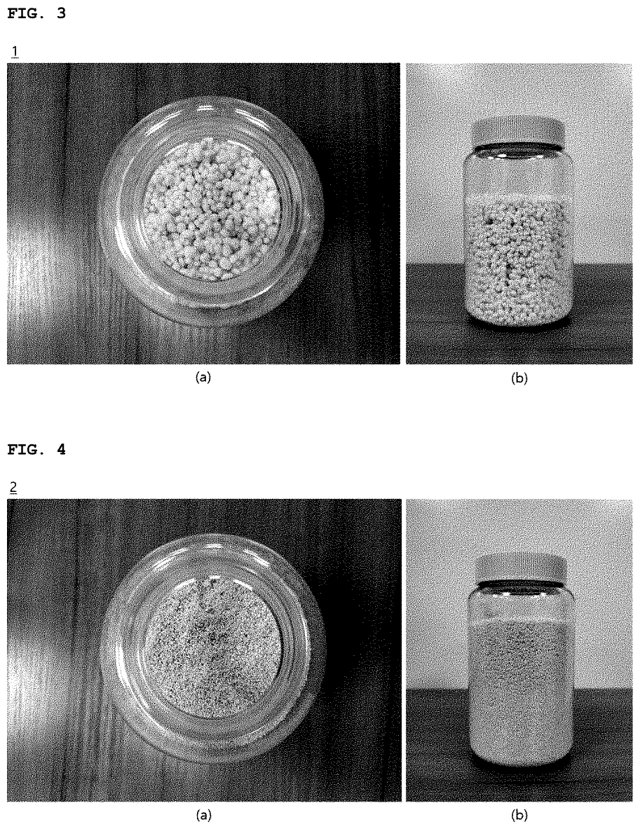

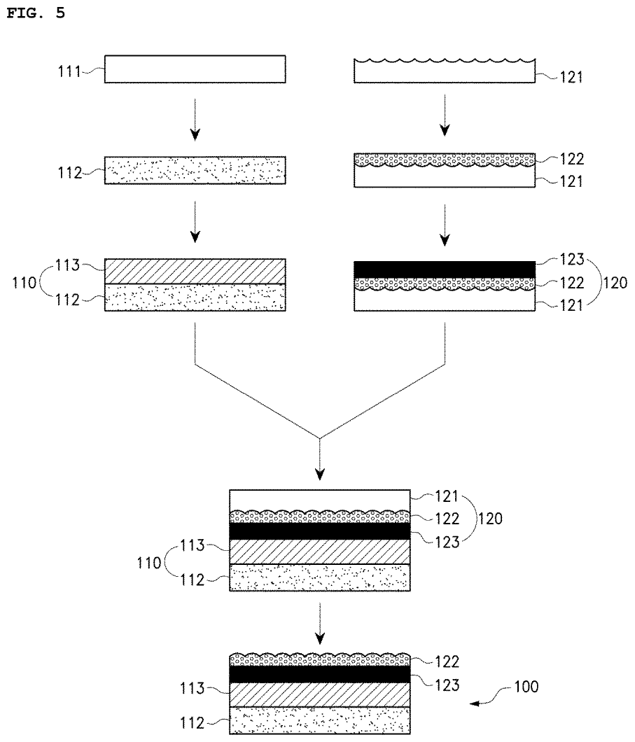

FIG. 3 is a view illustrating images of the first particles 1 separated by the classification device 10 according to the present disclosure, and FIG. 4 is a view illustrating images of the second particles 2 separated by the classification device 10 according to the present disclosure. Referring to FIGS. 3 and 4, the first particles 1 and the second particles 2 classified by particle size and component through the classification device 10 are identified.

Next, the crushed leather particles are mixed with the resin used in the manufacturing of the leather. The particles classified under vibration or ultrasonic waves may be dissolved in a solvent (for example, DMF) and then filtered for reuse, as illustrated in FIG. 1. When the particles are dissolved in the solvent and then filtered, they may be divided into a component in which the resin is dissolved in the solvent and a component in which the resin is dissolved in the solvent and the base sheet component is included together.

The component in which the resin is dissolved in the solvent may be used in manufacturing of wet-dry artificial leather, suede, or dry artificial leather. For example, it may be reused by mixing it in a resin impregnation process, a resin application process to form a resin layer, and a process of applying the resin to a release paper layer.

In addition, in the case of the component in which the resin is dissolved in the solvent and the base sheet component is included together, it may be difficult to apply it directly to a skin layer of a thin dry sheet because it contains the base sheet component. Therefore, it may be used by mixing it in the resin application process to form a relatively thick resin layer of wet-dry artificial leather or dry artificial leather. In some cases, when forming the resin layer, the crushed leather particles may be used by directly mixing them with the resin for forming the resin layer without dissolving them in the solvent.

In the present disclosure, the crushed leather particles may be used by mixing them with the resin when manufacturing wet-dry artificial leather. In relation to this, FIG. 5 a flowchart illustrating a method for manufacturing wet-dry artificial leather. Referring to FIG. 5, in the present disclosure, wet-dry artificial leather may be manufactured through a wet step of wet-impregnating a base sheet 111 with a resin to manufacture a resin-impregnated base sheet 112 and then applying the resin to an upper surface of the resin-impregnated base sheet 112 to manufacture a wet sheet 110 coated with a wet resin layer 113; a dry step of applying the resin to a release paper layer 121 to form a skin layer 122 and then stacking an adhesive layer 123 to manufacture a dry sheet 120; and a bonding step of arranging the wet resin layer 113 and the skin layer 122 to face each other and then bonding the wet sheet 110 and the dry sheet 120 with the adhesive layer 123.

In the wet step, the term “wet” refers to the process of coagulation using water as the main component after impregnation or coating of a resin layer. First, when the base sheet 111 is impregnated with the resin, the resin permeates into empty spaces of the base sheet 111 to manufacture the resin-impregnated base sheet 112. After the resin-impregnated base sheet 112 is primarily coagulated, the wet resin layer 113, which is formed by applying the resin again to the surface of the resin-impregnated base sheet 112, is integrated to complete the wet sheet 110 with a cushioning function. However, it is preferable that after the surface of the resin-impregnated base sheet 112 is coated with the wet resin layer 113, the resin-impregnated base sheet is subjected to secondary coagulation, water washing, and drying.

In the dry step, the term “dry” refers to the process of drying with hot air without coagulation using water as the main component, unlike the wet process. After the resin is applied to the release paper layer 121 to form the skin layer 122, the adhesive layer 123 is stacked to manufacture the dry sheet 120. The release paper layer 121 may have a pattern such as a leather pattern, geometric pattern, or grid pattern. When the skin layer 122 is formed by applying the resin to the release paper layer 121, the pattern such as a leather pattern, geometric pattern, or grid pattern of the release paper layer 121 is transferred to a surface of the skin layer 122. Next, an adhesive for bonding to the wet sheet 110 is applied to the surface of the skin layer 122 to form the adhesive layer 123, thereby completing the dry sheet 120. Then, an outer surface of wet-dry artificial leather manufactured by combining the dry sheet 120 and the wet sheet 110 is formed to have the skin layer 122.

In the bonding step, the wet resin layer 113 and the skin layer 122 are arranged to face each other and then the wet sheet 110 and the dry sheet 120 are bonded with the adhesive layer 123. Thereafter, the release paper layer 121 is peeled off to manufacture wet-dry artificial leather.

In order to combine the previously prepared wet sheet 110, which is a wet semi-finished product, with the dry sheet 120, which is a dry semi-finished product, the wet resin layer 113 and the skin layer 122 are arranged to face each other with the adhesive layer 123 interposed therebetween. After the wet sheet and the dry sheet are bonded together, the release paper layer 121 is peeled off. The wet-dry artificial leather is shipped after a final inspection. Here, the peeled release paper layer 121 has the advantage of being recyclable multiple times.

In particular, when producing the wet-dry artificial leather, the previously prepared crushed leather particles may be mixed with the resin used in the wet or dry step according to particle size or component. Specifically, the crushed leather particles may be dissolved in a solvent, filtered, and used separately in the wet or the dry step. In addition, a stardust pattern may be formed on the surface of the skin layer 122 by mixing the crushed leather particles with the resin applied to the release paper layer 121.

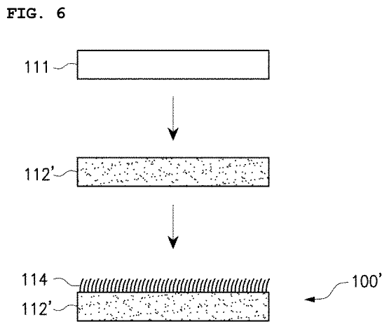

In the present disclosure, the crushed leather particles described above may be used by mixing them with the resin when manufacturing suede. In relation to this, FIG. 6 is a flowchart illustrating a method for manufacturing suede. Referring to FIG. 6, in the present disclosure suede may be manufactured through a suede base manufacturing step of impregnating a base sheet 111 with a resin in a wet or dry manner and drying it to manufacture a suede base 112′, and a buffing step of polishing a surface of the suede base 112′.

When the base sheet 111 is impregnated with the resin, the resin permeates into empty spaces of the base sheet 111 to manufacture the suede base 112′. When the base sheet 111 is impregnated with the resin, the resin permeates throughout the inside of the base sheet 111 and the resin is also adhered to a surface of the base sheet 111. The resin on the surface is scraped off through a buffing (grinding with sandpaper) process. Then, fine fibers (hairs) 114 are formed on the surface of the suede base, creating artificial leather similar to suede. Consequently, the entire process of manufacturing the dry sheet 120 by applying the resin to the release paper layer 121 to form the skin layer 122 and then stacking the adhesive layer 123 is omitted, and when the base sheet 111 is impregnated, dried, and buffed, the process of manufacturing suede is completed. In the impregnation process of suede, when a wet impregnation method is adapted, it is preferable that coagulation using water as the main component and washing are performed. When a dry impregnation method is adapted, drying is performed using hot air.

However, since the base sheet 111 has to be impregnated with the resin, the types of the base sheet 111, which can become suede, may include fabric, knitted fabric, non-woven fabric, and the like, excluding a film and natural leather.

Even during manufacture of suede, crushed leather particles may be classified by particle size or component and mixed with the resin used in the suede base manufacturing step. To this end, the crushed leather particles may be dissolved in a solvent, filtered, and used in the impregnation process.

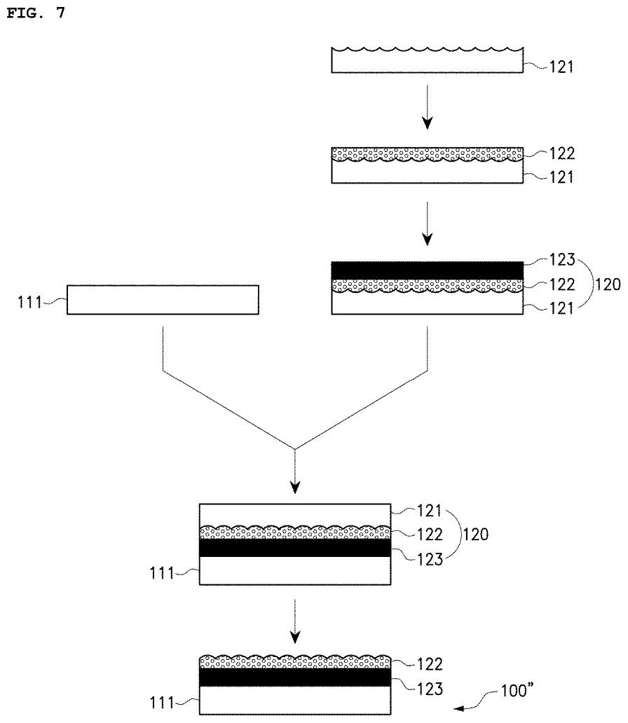

In the present disclosure, the crushed leather particles described above may be used by mixing them with the resin when manufacturing dry artificial leather. In relation to this, FIG. 7 is a flowchart illustrating a method for manufacturing dry artificial leather. Referring to FIG. 7, in the present disclosure, dry artificial leather may be manufactured through a base sheet preparation step of preparing a base sheet 111; a dry step of applying a resin to a release paper layer 121 to form a skin layer 122 and then stacking an adhesive layer 123 to manufacture a dry sheet 120; and a bonding step of arranging the base sheet 111 and the skin layer 122 to face each other and then bonding the base sheet 111 and the dry sheet 120 with the adhesive layer 123. In addition, in the base sheet preparation step of dry artificial leather, the base sheet may be dry-impregnated or coated with a dry resin layer 113 after dry impregnation. In this case, since the impregnation and resin layer application method is a dry method, drying is performed using hot air without coagulation using water as the main component.

Crushed leather particles may be classified by particle size or component and mixed with the resin used in the base sheet preparation step and dry step. In this case, the crushed leather particles may be used by dissolving them in a solvent and then filtering them. In addition, the crushed leather particles may be mixed with the resin applied to the release paper layer 121 to form a stardust pattern on a surface of the skin layer 122.

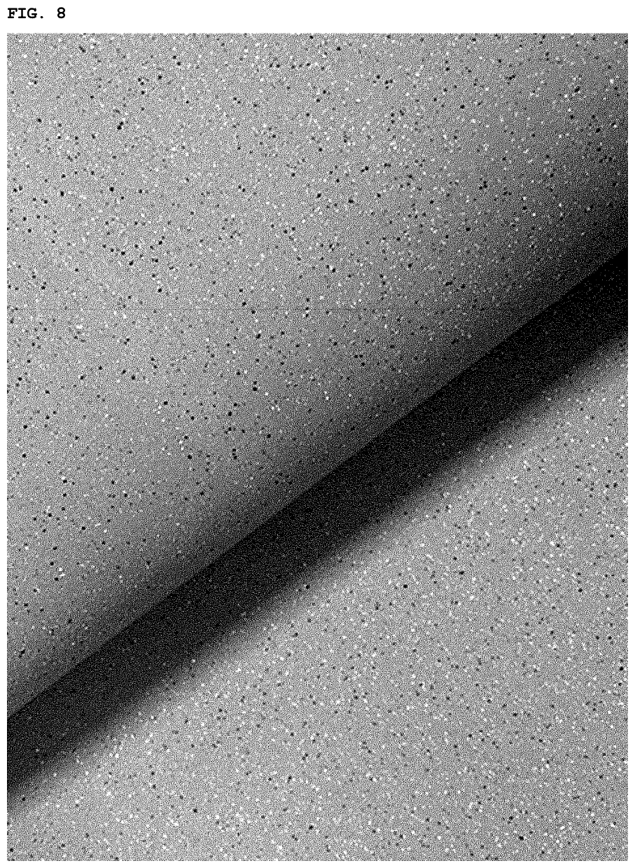

Regarding the stardust pattern, the stardust pattern formed on the surface of the skin layer 122 is confirmed through FIG. 8. The stardust pattern refers to a pattern in which granular crushed leather particles are randomly arranged on the skin layer 122 to resemble a cluster of stars in the night sky. By including the crushed leather particles in the skin layer 122, design elements are added to a surface of recycled leather.

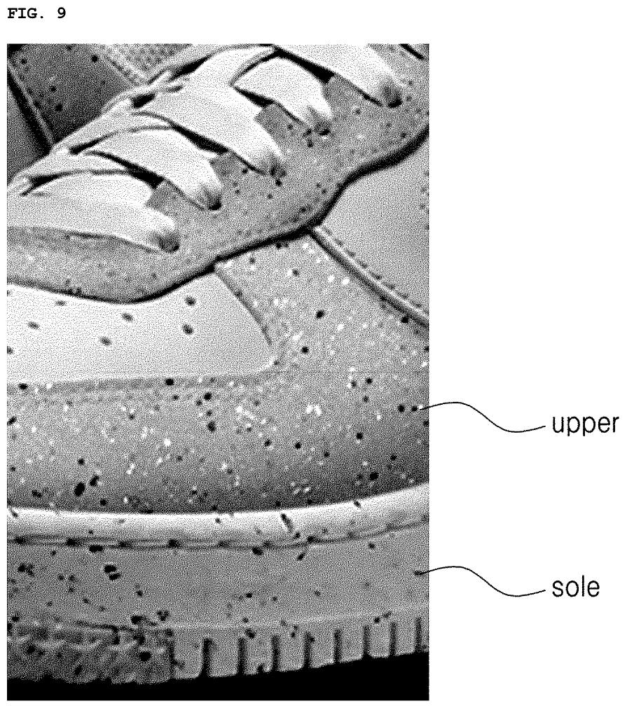

FIG. 9 is a product image of recycled leather to which a skin layer 122 with a stardust pattern on a surface is applied, illustrating an enlarged view of the upper and the sole of a shoe. For the upper and the sole, the skin layer 122 forming the surface of the recycled leather may be applied to the upper, and in some cases, crushed leather particles may also be included in the sole.

In summary, the present disclosure relates to a method for manufacturing leather by using a resin and a base sheet, and is characterized in that crushed leather particles are prepared by crushing surplus leather products, leather scraps generated during cutting or production, or unusable leather products and then the crushed leather particles are mixed with the resin used in the manufacturing of the leather.

According to these characteristics, surplus leather products, leather scraps generated during cutting or production, or unusable leather products are collected, crushed, classified, and reused rather than being discarded, thereby preventing environmental pollution and achieving zero waste. In addition, crushed leather particles are included in the skin layer 122, thereby improving design elements of the recycled leather surface. Recycled leather manufactured in this way has the advantage of being widely used in various products such as footwear, furniture, bag products, clothing, and car seats.

The above-described embodiments are merely an example of the present disclosure, and various modifications and variations may be made to the present disclosure by those skilled in the art to which the present disclosure pertains. Accordingly, the embodiments of the present disclosure are provided to describe, rather than limiting, the present disclosure, and the scope of the present disclosure should be not limited to the embodiments. The scope of the present disclosure is defined by the appending claims, and all technical spirit of the equivalents of the present disclosure should be construed as included in the scope of the present disclosure.

1. A method for manufacturing recycled leather by using leather, the method manufacturing artificial leather or natural leather (hereinafter referred to as ‘leather’) by using a resin and a base sheet, and the method comprising:
preparing crushed leather particles by crushing surplus leather products, leather scraps generated during cutting or production, or unusable leather products; and
mixing the crushed leather particles with the resin used in the manufacturing of the leather.

2. The method of claim 1, wherein the preparing of the crushed leather particles is performed by crushing the leather and classifying the crushed leather by particle size or component to prepare the crushed leather particles.

3. The method of claim 2, wherein the crushed leather particles include a base agglomerate that results from entangling base sheet components when classifying the crushed leather by particle size or component.

4. The method of claim 3, wherein the base agglomerate is used when mixed with the resin or is discarded.

5. The method of claim 1, wherein the base sheet is at least one of a film, fabric, knitted fabric, non-woven fabric, and natural leather.

6. The method of claim 1, wherein the leather is wet-dry artificial leather manufactured by: a wet step of wet-impregnating the base sheet with the resin to manufacture a resin-impregnated base sheet and then applying the resin to an upper surface of the resin-impregnated base sheet to manufacture a wet sheet coated with a wet resin layer (hidden layer) (hereinafter referred to as ‘resin layer’); a dry step of applying the resin to a release paper layer to form a skin layer and then stacking an adhesive layer to manufacture a dry sheet; and a bonding step of arranging the resin layer and the skin layer to face each other and then bonding the wet sheet and the dry sheet with the adhesive layer, wherein the crushed leather particles are mixed with the resin used in the wet step or the dry step.

7. The method of claim 1, wherein the leather is suede manufactured by: a suede base manufacturing step of impregnating the base sheet with the resin to manufacture a suede base; and a buffing step of polishing a surface of the suede base, wherein the crushed leather particles are mixed with the resin used in the suede base manufacturing step.

8. The method of claim 1, wherein the leather is dry artificial leather manufactured by: a base sheet preparation step of preparing the base sheet; a dry step of applying the resin to a release paper layer to form a skin layer and then stacking an adhesive layer to manufacture a dry sheet; and a bonding step of arranging the base sheet and the skin layer to face each other and then bonding the base sheet and the dry sheet with the adhesive layer, wherein the crushed leather particles are mixed with the resin used in the dry step.

9. The method of claim 8, wherein the base sheet preparation step is performed by dry-impregnating the base sheet with the resin to manufacture a resin-impregnated base sheet and then applying the resin to an upper surface of the resin-impregnated base sheet to prepare the base sheet coated with a dry resin layer, wherein the crushed leather particles are mixed with the resin used in the base sheet preparation step.

10. The method of claim 6, wherein the crushed leather particles are used by classifying the crushed leather particles by particle size or component.

11. The method of claim 6, wherein the crushed leather particles are used by dissolving the crushed leather particles in a solvent and then filtering the crushed leather particles.

12. The method of claim 6, wherein the crushed leather particles are mixed with the resin applied to the release paper layer to form a stardust pattern on a surface of the skin layer.
